(19) United States
(12) Patent Application Publication
(10) Pub. No.: US 2013/0166922 A1
(43) Pub. Date: Jun. 27, 2013

(54) METHOD AND SYSTEM FOR FRAME BUFFER PROTECTION

(71) Applicants: Daniel W. Wong, Cupertino, CA (US); Warren Fritz Kruger, Sunnyvale, CA (US); David I.J. Glen, Toronto (CA); Gongxian J. Cheng, Toronto (CA)

(72) Inventors: Daniel W. Wong, Cupertino, CA (US); Warren Fritz Kruger, Sunnyvale, CA (US); David I.J. Glen, Toronto (CA); Gongxian J. Cheng, Toronto (CA)

(73) Assignees: ATI TECHNOLOGIES ULC, Markham (CA); ADVANCED MICRO DEVICES, INC., Sunnyvale, CA (US)

(21) Appl. No.: 13/599,609

(22) Filed: Aug. 30, 2012

Related U.S. Application Data
(60) Provisional application No. 61/579,714, filed on Dec. 23, 2011.

(51) Int. Cl. G06F 12/14

(52) U.S. Cl. 713/193; 711/163; 711/E12.092

(57) ABSTRACT

When content, such as premium video or audio, is decoded, the content is stored in protected memory segments. Read access to the protected memory segments from a component not in a frame buffer protected (FBP) mode is blocked by a memory controller. The memory controller also blocks components in the FBP mode from writing to unprotected memory segments. The content may be processed by a processing engine operating in the FBP mode and may only be written back to protected memory segments. The memory segment may later be marked as unprotected if the memory segment is no longer needed. If the content is encrypted in protected memory, the encrypting key associated with the memory segment may be removed. If the content is stored in the clear, the protected memory segments are scrubbed before releasing the segments for use as unprotected memory segments.

### CROSS REFERENCE TO RELATED APPLICATION

This application claims priority to U.S. Provisional Application No. 61/579,714, filed Dec. 23, 2011, the contents of which are hereby incorporated by reference herein.

### FIELD OF INVENTION

This application is related to an integrated circuit including, but not limited to, microprocessors, central processing units (CPUs), graphics processing units (GPUs), accelerated processing units (APUs), and the like.

### BACKGROUND

Unauthorized copying or reproduction of digital content has become a significant issue for content owners. For example, premium content, such as movies or other audio/visual content, can be captured during playback and reproduced without authorization of the content owners.

To prevent such unauthorized copying, content may be encrypted before being stored in memory (e.g., dynamic random access memory (DRAM)) in encrypted form, and then decrypted on read back to be processed by a graphics processing unit (GPU). The processed results may be re-encrypted before being stored in memory. But this process is expensive in terms of silicon area, power, and system performance. In particular, all masked writes (i.e., not updating all bytes in the same transaction) will become read-modify-write operations and performance will degrade substantially.

Alternatively, access to protected content may be controlled via aperture mapping. In such a scheme, a central processing unit (CPU) can only read/write to aperture-mapped frame buffer memory segments. Unmapped frame buffer addresses (e.g., invisible heap) are accessible from the GPU, but are blocked from the host. But robust protection of the programming interface of these apertures may be difficult.

### SUMMARY OF EMBODIMENTS

A method and system for frame buffer protection is disclosed. When protected content such as premium video, audio, or the like is decoded, the audio and/or video samples from that content may be stored in protected memory segments. A component in the media pipeline will need to operate in a distinctive frame buffer protected (FBP) mode to process information stored in protected memory segments. These memory segments may be protected through access control, encryption, or both. In an access-based scheme, read access to these protected memory segments from a component not in a frame buffer protected (FBP) mode is blocked by a memory controller. For writes, the memory controller automatically marks a memory page as protected when it receives memory write transactions from a component working in the FBP mode. As such, an engine entering the FBP mode to read protected memory pages will write back results to protected memory segments. Alternatively, in a cipher based scheme, content written to protected memory segments is encrypted. A media processing component will need to operate in FBP mode to read information in protected memory segments with proper decryption from the memory controller. As soon as a component operates in the FBP mode, all memory writes from it will be encrypted by the memory controller. It is possible to use both access control and cipher protection to raise robustness, at the expense of implementation cost and performance overhead associated with both schemes.

The frame buffer protection mechanism may be first triggered when the decoder writes protected content to the frame buffer. This may be done by forcing the decoder to enter the FBP mode before granting access to a session key required for decrypting the content.

The memory pages storing the protected content may later be marked as unprotected if these memory pages are to be returned to the system for other uses. Before these protected memory segments can be freed up for general access, it is necessary to ensure that content in the protected memory segments is no longer accessible. If the content is encrypted before storing in protected memory pages, cipher keys associated with these protected memory pages may be erased. If the protected content is stored in the memory in plaintext form without encryption, hardware data scrubbing may be performed on these memory pages.

### BRIEF DESCRIPTION OF THE DRAWINGS

A more detailed understanding may be had from the following description, given by way of example in conjunction with the accompanying drawings, wherein:

FIG. 1 is a block diagram of an example system in which one or more embodiments may be implemented; and

FIG. 2 is a flow diagram of a process for protecting premium content.

### DETAILED DESCRIPTION OF EMBODIMENTS

The embodiments will be described with reference to the drawing figures wherein like numerals represent like elements throughout.

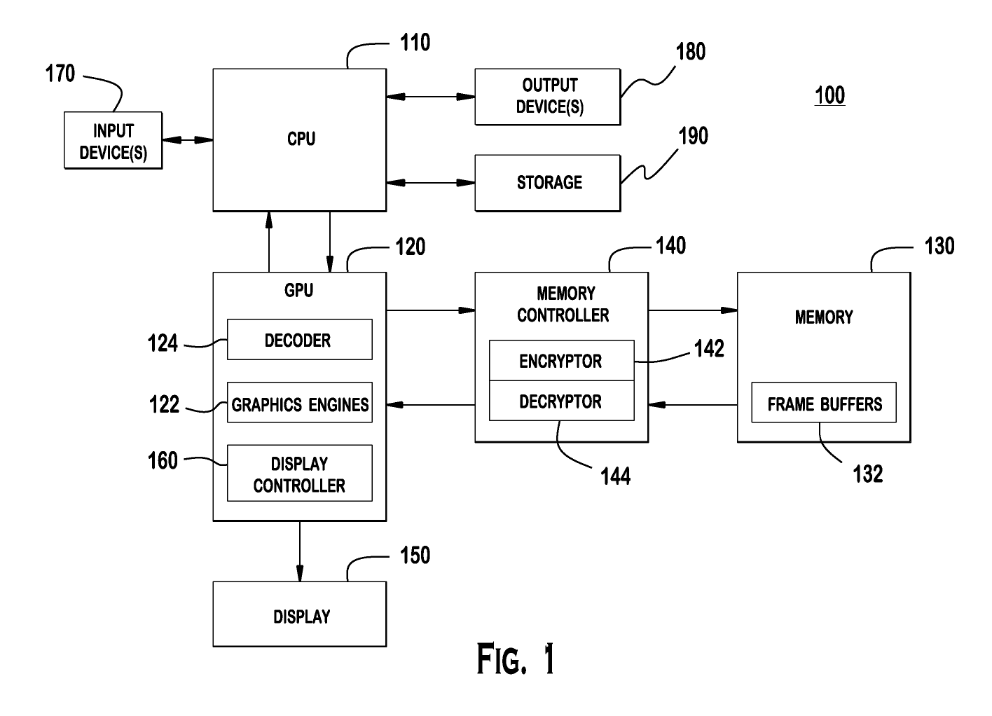

FIG. 1 is a block diagram of an example system in which one or more disclosed embodiments may be implemented. The system 100 may include a CPU 110, a GPU 120, a memory 130 having one or more frame buffers 132, a memory controller 140, a display 150, a display controller 160, one or more input devices 170, one or more additional output devices 180, and a storage 190. The CPU 110 is configured to run applications, drivers, and an operating system (OS). The GPU 120 is a specialized processor designed to accelerate the rendering of images in a frame buffer 132 intended for output to the display 150. The GPU 120 includes one or more graphics engines 122 and a decoder 124, plus many other components. It is understood that the system 100 may include additional components not shown in FIG. 1.

The driver, which is a software program executing on the CPU 110, directs or drives the GPU 120 to generate images with the help of acceleration engines embedded in the GPU 120. The driver includes executable instructions run in the CPU 110 to effect timing of the video data read out of the frame buffers 132 and displayed by the GPU 120 on the display 150. The driver is configured to be responsive to an interrupt signal received from the GPU 120 via the OS.

The memory 130 stores video data to be processed by the graphics engines 122 and video data that has been processed by the graphics engines 122 to be displayed on the display 150. The memory 130 may be any type of memory including, but not limited to, a volatile or non-volatile memory, a random access memory (RAM), a dynamic random access memory (DRAM), a video random access memory (VRAM), a synchronous dynamic random access memory (SDRAM), a cache, or the like. The frame buffers 132 in the memory 130 store video data frames prior to being displayed on the display 150. The frame buffers 132 may be allocated by the driver when a video playback is initiated by the application, and may be de-allocated at the conclusion of the video playback.

The memory controller 140 facilitates and may control access to the memory 130. The memory controller 140 may also include an encryptor 142 and a decryptor 144.

The display 150 may be any type of electronic display device such as a liquid crystal display (LCD) display, a light emitting diode (LED) display, a plasma display, a cathode ray tube (CRT) display, or the like. The display 150 may form part of the system 100 (e.g., included in a portable device such as a notebook, mobile phone, tablet, or the like) or may be removably connected to the system 100 (e.g., a secondary display for portable device, a desktop, or even remote from the system 100 such as in a server or wireless display arrangement). Although in FIG. 1, only one display 150 is shown, there may be multiple displays connected to the system 100, and the embodiments disclosed herein may be applied to systems having more than one display.

It should be noted that the system 100 shown in FIG. 1 is merely an example, and many variations are possible. For example, the CPU 110 and the GPU 120 may be incorporated in a single-chip package (e.g., an Accelerated Processing Unit (APU)). Additionally, there may be several CPUs and/or several GPUs. The memory controller 140 and/or the display controller 160 may be included in a single-chip package with the GPU 120 and/or the CPU 110. The memory 130 may be a system memory or a separate video memory may additionally be used.

The memory 130 may be located on the same die as the CPU 110 or the GPU 120, or may be located separately from the CPU 110 or the GPU 120. A separate video memory may be used, or alternatively, the video memory may be part of the main memory 130.

The input device(s) 170 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 180 may include additional displays, a speaker, a printer, a haptic feedback device, one or more lights, an antenna, or a network connection (e.g., a wireless local area network card for transmission and/or reception of wireless IEEE 802 signals). The storage 190 may include a fixed or removable storage, for example, a hard disk drive, a solid state drive, an optical disk, or a flash drive.

An input driver communicates with the processors 110/120 and the input devices 170, and permits the processors 110/120 to receive input from the input devices 170. An output driver communicates with the processors 110/120 and output devices 180, and permits the processors 110/120 to send output to the output devices 180. It is noted that the input driver and the output driver are optional software components (not shown), and that the system 100 will operate in the same manner if the input driver and the output driver are not present.

A new mode (a frame buffer protected (FBP) mode) is utilized for the components of the GPU 120 and other components of the system 100. In FBP mode, memory segments (e.g., memory pages) which store the protected content (i.e., premium content, such as audio, video, or the like) may be marked as protected (i.e., protected memory segments), and leaking of the protected content stored in the protected memory segments to unprotected memory segments is prevented. Every memory request coming from the GPU 120 is individually tagged with the FBP state of the requesting engine. When the FBP mechanism is enabled, the memory controller 140 guarantees that only the components in the FBP mode may access the content in the protected memory segments, and the content read from the protected memory segments may be written back to the protected memory segments, for example, after processing by the components of the GPU 120.

It is noted that a component operating in FBP mode is allowed to read from both protected memory segments and unprotected memory segments. But a component operating in FBP mode may only write back to protected memory segments.

In one embodiment, the FBP mechanism is connected with a session key established between a media application and acceleration hardware. When an application (e.g., a DVD player) starts, the application may perform a procedure to authenticate the hardware and software components of the system 100 to ensure that the hardware or software components are trustworthy for content consumption. The authentication between the application and the hardware/software (e.g., between the application and the GPU 120 or a separate processor or processing component that controls the GPU 120) is performed before the protected content is presented from the application to the GPU 120 for display. A separate processor or processing component may be provided to handle the cryptographic tasks and key management, or the processing component may be included in the GPU 120. Through the authentication procedure, the application and the GPU 120 (or a separate processor) agree/obtain a session key, which is a shared secret between the application and the GPU 120 (or a separate processor). In this embodiment, the authentication process may be enhanced to specify that the FBP mode is required to access the session key for content decryption. The session key (or other key(s) derived or obtained using the session key) may be used by the application for encrypting and decrypting instructions and/or data to the GPU 120. It is noted that any conventional encryption or authentication algorithm may be employed, and the embodiments disclosed herein are not limited to any specific encryption or authentication algorithm.

As the encrypted content (usually in compressed form) is presented from the application to the GPU 120 for decoding, the decoder 124 decrypts and decodes the content, and stores the decoded uncompressed data in a frame buffer 132. To decrypt the compressed data from the application, the decoder 124 needs access to the session key established with the application. In case the application has specified that FBP mode is required for access to that session key, the decoder 124 enters the FBP mode before it is granted access to the session key. The application utilizes the session key to protect the compressed content presented to the GPU 120. When the decoder 124 is in the FBP mode, the decoded content will be stored in the memory 130 (e.g., the frame buffer 132) in protected memory segments. The memory controller 140 detects that the decoder 124 is in the FBP mode and marks the memory segments (e.g., memory pages) for storing the decoded content as protected.

In this embodiment, the configuration of the FBP mode for various processing engines inside GPU 120 may be done either by hardware, software (e.g., a driver), or a combination of both.

As the instructions are issued to the GPU 120, the driver may configure the graphics engines 122 (either a particular graphics engine or all graphics engines) in the GPU 120 (or other units of the system 100 such as the display controller 160) to enter the FBP mode. A graphics engine 122 reads the data from the memory 130 for a specific operation(s) on the data and writes the processed data back to the memory 130. The graphics engines 122 need to be in the FBP mode to read content from the protected frame buffer 132 (e.g., a memory segment that is marked as protected), and when the graphics engines 122 are in the FBP mode, the processed content is written back to the protected memory segments in frame buffer 132. This process ensures that protected data always stays protected.

In the FBP mode, the protected content remains in the protected memory segments, and access to the protected content by unauthorized software is blocked by the memory controller 140. The memory segments allocated for the frame buffers 132 may be automatically marked as protected or unprotected. Once marked as protected, the protected memory segments may not be read by the untrusted software or hardware. If any untrusted software or hardware attempts to read from the protected memory segments, a protection mechanism may be implemented, such as reading back some predefined or random values, faulting the bus, stopping the processor, or the like. The memory controller 140 enforces these rules such that write requests sourced from protected content are written back into protected memory segments and read requests from protected memory segments from software or hardware components that are not in FBP mode are blocked.

In another embodiment, the player application may make requests to the driver to apply frame buffer protection to the buffers that it uses for content consumption. In this case, the driver may set up processing engines in the GPU 120 to go in and out of the FBP mode on a per-job basis. The memory controller 140 continues to enforce the same set of access policies for the protected memory segments; however, the association between the FBP mechanism and the session key may or may not be enforced.

Memory paging may be implemented with a page table(s) for virtualizing the physical memory. In paging, the memory address space is divided into small pieces, called pages. Using a virtual memory mechanism, each page may reside in any location of the physical memory. A set of protection status flags, each associated with a page of memory, may be marked as either protected or unprotected. At runtime, the protection status of each memory page may change dynamically. The protection status flags may be stored in an embedded storage in the GPU 120 or, alternatively, in an external memory reserved for this purpose. For the case of cipher-based FBP, these per page protection flags may be stored as part of the page table without compromising security.

With a cipher-based FBP scheme, protected content may be stored in the frame buffer 132 in encrypted form. The protection status flag signals the memory controller to apply cryptographic transformations (e.g., encryption) for memory writes and the corresponding inverse cryptographic transformations (e.g., decryption) for memory reads. For example, the data processed by the graphics engines 122 may be encrypted by the encryptor 142 before being stored in the protected memory segments and decrypted by the decryptor 144 after being read from the frame buffer 132. The memory cipher key used by the memory controller 140 is accessible to hardware only. The actual value of the memory cipher key may not be exposed to the software stack. But the renewal of memory cipher key may be done under software control. In this arrangement, the memory controller 140 decrypts read requests from protected memory segments when the requesting engine is in the FBP mode. Otherwise, the memory controller 140 may return encrypted data to the requester. For write transactions, the memory controller 140 may choose to encrypt write requests to both protected memory segments and unprotected memory segments when the requesting engine is in the FBP mode. Alternatively, the memory controller 140 may drop or corrupt the write request when the output is targeting an unprotected memory segment.

A cipher-based FBP solution may choose to protect all memory segments with the same memory cipher key or multiple memory cipher keys. When multiple memory cipher keys are involved, each protected memory segment may be protected by one of the keys in the pool of memory cipher keys. Similar to the protection status flags, the cipher key association may be stored in an embedded storage in the GPU 120, in an external memory reserved for this purpose, or as part of the page table.

Alternatively, the data processed by the graphics engines 122 may be stored in the protected memory segments in plaintext form without encryption. In this case, the memory controller 140 exercises access control to protected memory segments only. In this access-based FBP arrangement, the memory controller 140 processes read requests from protected memory segments when the requesting engine is in the FBP mode. Otherwise, the memory controller 140 may return some dummy values to the requester. For write transactions, the memory controller 140 may automatically mark all pages touched by requesting engines in the FBP mode as protected. Alternatively, the memory controller 140 may drop or corrupt the write request from an engine in FBP mode targeting an unprotected memory segment.

Alternatively, a system may use the same setup to implement both access control and cipher protection on protected pages.

The protected memory pages may be returned to the OS for general use (e.g., marked as unprotected) if the application indicates that the protected memory pages are no longer needed. For example, the frame buffers 132 may be de-allocated at the conclusion of the video playback (e.g., when the application exits).

If protected content is stored in the frame buffer 132 in plaintext form, memory scrubbing (i.e., data scrubbing) may be performed for the de-allocated memory pages (e.g., by hardware) such that these de-allocated memory pages are overwritten with random or pseudo-random noise, all zeros, or the like. If protected content is stored in the frame buffer 132 in encrypted form, the memory cipher key associated with the de-allocated memory pages may be erased. In this case, memory scrubbing may not be necessary.

The memory protection mechanism is not limited to premium content consumption. It may also be used to protect user content, including identity protection and data protection for electronic commerce transactions.

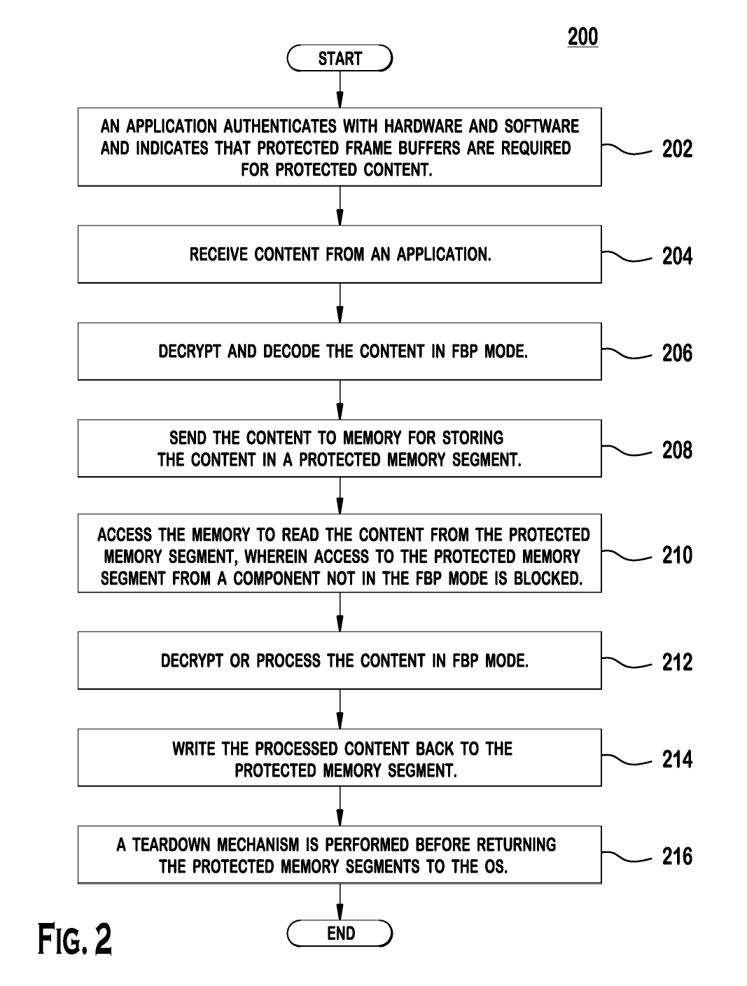

FIG. 2 is a flow diagram illustrating one embodiment of a process 200 for protecting premium content. An application authenticates with hardware and software components of the system, and indicates that protected frame buffers are required for the protected content (step 202). A GPU 120 receives content from an application (step 204). A decoder 124 in the GPU 120 decrypts and decodes the protected content in FBP mode (step 206). The decoder must be in the FBP mode before granting access to a session key for decrypting the content. The GPU 120 sends the decrypted and decoded content to memory for storing the content in a protected memory segment (step 208).

Storing the content in the protected memory segment triggers the following procedure. A graphics engine 122 in the GPU 120 accesses the memory 130 to read the content from the protected memory segment. Access to the protected memory segment is granted only from a component in the FBP mode, and access from a component not in the FBP mode is blocked (step 210). The graphics engine 122 reads from and processes the protected content in FBP mode (step 212) and writes the processed content back to the protected memory segment (step 214). Once the protected memory segments are no longer needed, a teardown mechanism is performed to place the protected memory segments into an unprotected state before returning the memory segments to the OS (step 216).

Although features and elements are described above in particular combinations, each feature or element may be used alone without the other features and elements or in various combinations with or without other features and elements. The apparatus described herein may be manufactured by using a computer program, software, or firmware incorporated in a non-transitory computer-readable storage medium for execution by a general or specific purpose computer or a processor. Examples of computer-readable storage mediums include, but are not limited to, a read-only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments disclosed above may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the embodiments.

The computer-readable storage medium may store a code for describing a structure and/or a behavior of a module configured to decode content received from an application, process the content, and control access to a memory, such that access to a protected memory segment from a component not in an FBP mode is blocked, and content processed by the graphics engine is written back to the protected memory segment.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method for protecting a frame buffer storing content, comprising:
sending the content to a memory for storing the content in a protected memory segment; and
accessing the memory to read the content from the protected memory segment, wherein access to the protected memory segment from a component not in a frame buffer protected (FBP) mode is blocked by a memory controller.

2. The method of claim 1, wherein the memory controller automatically marks a memory page in which the content is stored as protected on a condition that the content is received from a component in the FBP mode.

3. The method of claim 1, further comprising:
outputting on a display the content read from the protected memory segment.

4. The method of claim 1, wherein:
the content is received from an application and is processed before being stored in the protected memory segment;
the content read from the protected memory segment is processed; and
the processed content is written back to the protected memory segment.

5. The method of claim 4, wherein:
processing the content before storing it in the protected memory segment includes decoding the content; and
a decoder that decodes the content enters the FBP mode before granting access to a session key for decrypting the content.

6. The method of claim 5, wherein a frame buffer protection mechanism is triggered on a condition that the decoder stores the content in the memory.

7. The method of claim 4, further comprising:
applying cryptographic transformations to the content before writing the processed content back to the memory; and
applying corresponding inverse cryptographic transformations to the content when reading the content from the memory.

8. The method of claim 7, wherein the applying cryptographic transformations and the applying corresponding inverse cryptographic transformations are performed by the memory controller.

9. The method of claim 7, wherein:
the applying cryptographic transformations is performed by an encryptor; and
the applying corresponding inverse cryptographic transformations is performed by a decryptor.

10. The method of claim 1, further comprising:
marking a memory page in which the content is stored as unprotected on a condition that the memory page is no longer needed; and
removing a cipher key associated with the memory page.

11. The method of claim 1, wherein the content is stored in the memory in a plaintext form without cryptographic transformations, and the method further comprising:
marking a memory page in which the content is stored as unprotected on a condition that the memory page is no longer needed; and
performing data scrubbing on the memory page.

12. The method of claim 1, further comprising:
performing a protection mechanism if an attempt to read the content from the protected memory segment from a component not in the FBP mode is detected, whereby access to the content is effectively blocked.

13. The method of claim 1, wherein the component is located in any one of: a central processing unit, a graphics processing unit, or an accelerated processing unit.

14. The method of claim 1, wherein the component is any one of: a decoder, a graphics engine, or a display controller.

15. A system for protecting a frame buffer storing content, comprising:
a processor, including a graphics engine configured to process the content; and
a memory controller configured to control access to a memory,
wherein the content is stored in a protected memory segment, and access to the protected memory segment from a component not in a frame buffer protected (FBP) mode is blocked by the memory controller.

16. The system of claim 15, wherein the memory controller is configured to automatically mark a memory page in which the content is stored as protected on a condition that the content is received from a component in the FBP mode.

17. The system of claim 15, wherein the memory controller is configured to automatically apply cryptographic transformations to a memory page in which the content is stored as protected on a condition that the content is received from a component in the FBP mode.

18. The system of claim 15, wherein the processor is configured to output on a display the content read from the protected memory segment.

19. The system of claim 15, further comprising:
a decoder for decoding content received from an application, wherein the content processed by the graphics engine is written back to the protected memory segment.

20. The system of claim 19, wherein the decoder enters the FBP mode before granting access to a session key for decrypting the content.

21. The system of claim 20, wherein a frame buffer protection mechanism is triggered on a condition that the decoder stores the content in the memory.

22. The system of claim 15, further comprising:
an encryptor for applying cryptographic transformations to the content before writing the processed content back to the protected memory segment; and
a decryptor for applying inverse cryptographic transformations to the content after reading from the protected memory segment, wherein the memory controller is configured to mark a memory page in which the content is stored as unprotected on a condition that the memory page is no longer needed, and a cipher key associated with the memory page is removed.

23. The system of claim 15, wherein:
the content is stored in the memory in a plaintext form without cryptographic transformations;
the memory controller is configured to mark a memory page in which the content is stored as unprotected on a condition that the memory page is no longer needed; and
the system further comprises a data scrubbing means for performing data scrubbing on the memory page.

24. The system of claim 15, further comprising:
a means for performing a protection mechanism if an attempt to read the content from the protected memory segment from a component not in the FBP mode is detected.

25. The system of claim 15, wherein the processor includes any one of: a central processing unit, a graphics processing unit, or an accelerated processing unit.

26. The system of claim 15, wherein the component is any one of: a decoder, the graphics engine, or a display controller.

27. A computer-readable storage medium storing a set of instructions for execution by a processor to protect a frame buffer storing content, the set of instructions comprising:
a code segment for sending the content to a memory for storing the content in a protected memory segment; and
a code segment for accessing the memory to read the content from the protected memory segment, wherein access to the protected memory segment from a component not in a frame buffer protected (FBP) mode is blocked by a memory controller.

28. The computer readable storage medium of claim 27, wherein the set of instructions further comprises:
a code segment for decoding the content received from an application; and
a code segment for processing the content, wherein the processed content is written back to the protected memory segment.
